(19) United States
(12) Patent Application Publication
(10) Pub. No.: US 2002/0135178 A1
(43) Pub. Date: Sep. 26, 2002

(54) Multiple pocket shopping list pad

(76) Inventor: Anita Rzadzki, Skokie, IL (US)

Correspondence Address: Sidney N. Fox, Suite 260, 555 Skokie Blvd., Northbrook, IL, 60062, US

(21) Appl. No.: 09/769,560

(22) Filed: Jan. 25, 2001

(51) Int. Cl. B42D 3/00; B42D 7/00

(52) U.S. Cl. 281/45

(57) ABSTRACT

This invention provides a bound multi-page list pad having a stack of dual-pages,each comprising a horizontally lined top thin sheet and a second sheet joined along three sides to define a side-opening pocket and the top sheet capable of receiving a written shopping list or the like, and the pocket and a backing member, the stack being bound at its upper end. The pocket is capable of receiving coupons particularly related to the items listed on the top sheet. The second sheet is provided with tabs to facilitate access to the respective pages. A cover sheet may be provided. The pages may be scored adjacent the top end thereof for detachment from the stack. The backing member may be provided with a magnetic strip to enable mounting of the pad on a metallic surface, say a refrigerator. Other indicia, i.e. notes, reminders, etc. can be scribed on the top sheet of the dual-pages in addition to or in lieu of a shopping list.

### FIELD OF THE INVENTION

This invention relates generally to the provision of a convenient multiple pocket shopping list pad and more particularly provides a bound thin paper pad comprising a plurality of bound dual pages, each dual page having a side-opening pocket capable of receiving for temporary storage one or more small individual sheets such as coupons, tickets, receipts and other like small paper items for selective use in conjunction with the notes inscribed upon the selected dual page.

### BACKGROUND OF THE INVENTION

One activity that is common to all individuals involves the shopping experience undertaken regularly by men, women and children alone or in concert with others. Among these activities are the periodically repeated, often daily or weekly visits to the retail establishments such as grocery stores, shopping malls, drug stores, fruit stores, hardware stores, department stores, clothing stores and the like.. Conventionally this activity involves preparation of a written listing of the individual items which are to be purchased. The shopper also conventionally make a shopping list itemizing these individual items for each establishment to be visited. These lists are drafted according to need, commonly with consultation of newspaper advertisements identifying sales and/or special offers, and, of course, including special discount coupons which are to be clipped from the advertisements for presentation to the cashiers at the close of the shopping trip through each grocery store or other retail establishment.

Often, these lists are made on small pieces of scratch paper or memo notes, which are assembled as by clipping with paper clips or stapled together, and are often plural, one or more for each store. The coupons are collected individually and gathered together for storage either in a packet, purse, in a conventional envelope, either separated in groups or mixed in a single container. More often, they are carried together and commonly mixed so as to require sorting at a more inconvenient time or location. More often than not, the critical list or lists are lost and more than desired, the coupon to be retrieved is mixed up or not available when presentation is necessary. Organization is difficult, particularly, when time is of the essence, the demands of children must be needed, many different tasks present themselves to the shopper while the preparation is made for the shopping trip.

The conventional day to day shopper often is faced with a dilemma in the efforts to be organized and efficient. Shopping lists are made, usually on home made pads that disappear when needed. Often items that are needed are written on separate pieces of scratch paper which are stuck upon a cabinet door or the like, for ready reference. These loose note pieces are often lost. Larger reminders often become lost. Lists are made, lost and redone. Frustration often results.

It is quire common to receive weekly flyers from retail shops, such as grocery supermarkets, drug stores, etc. In addition, coupon books or booklets are distributed in addition to the weekly sale flyers. Often one list is written for two or three different stores and applying paper clips to all the different vendors' coupons for goods on the shopping list. When the shopping task is initiated, the list is retrieved but more often, the coupons are not clipped to the list, mixed up within the purse or pocket, and later found when the shopping is completed, and therefor never used. In many instances, the shopper holds the clipped list and must fan through the assembled coupons to check an item, and, in the process, the clip falls off, leaving the list and/or the coupons scattered. In a frustrated state, the shopper turns to envelopes, inserting all the coupons in envelopes, writing the list on the front side of the envelope and inserting the coupons into the interior of the envelope. As often, the shopping trip involves traveling to and from several stores and thus involves a bundle of coupon carrying envelopes, taking up considerable spaced in purse or pocket. Where seeking and purchasing gifts are involved, it has been found to necessitate obtaining and keeping receipts for purchases so that if the giftee would need a receipt so as to effect a return or exchange, these receipts often are lost or misplaced, leading to disappointments. This leads the shopper to utter the conventional words “there must be a better way!”

Often, the shopper is faced with selected individual coupons from a sheave of miscellaneous coupons, some of which are not selected to be used, so sorting is required and commonly, not at a convenient time. The shopper fails to find the coupon for the desired item, leading to the frustration of the shopper who often finds the desire coupon mixed up with discarded coupons. Finding of the list from among the other items in the purse or pocket is difficult and maintaining both the list and accumulation of notes and coupons in good order becomes a serious problem.

Accordingly, organization becomes a necessity and gives rise to the need for a convenient solution, yet to be adequately provided by the prior art seeking to provide such solution. Among the prior attempts were described in the following United States Patents:

| | | | |
|---|---|---|---|
| No. | 5,788,073 | Suryk | Aug. 4, 1988 |
| | 5,170,889 | Cue | Dec. 5, 1992 |
| | 4,802,575 | Martin | Feb. 7, 1989 |
| | 4,932,976 | Ciarcia et al | June 12, 1990 |
| | 4,415,183 | Benham | Nov. 15, 1983 |

Suryk discloses a foldable organizer for grocery shopping consisting of a rigid panel forth grocery shopping consisting of a first rectangular panel and a second rectangular panels, each of the panels being the size of a conventional business envelope, the panels being formed of a relatively inflexible material. The panels are joined by a fold and a frame formation is provided along the opposite slides and bottom of the first panel defining an open shute. An envelope is received in the chute, said envelope carrying a preprinted listing identifying a pre-printed standardized shopping list of commonly purchased grocery items preceded by check-off blanks adjacent the items on the preprinted list. The two panels are joined by a contiguous flexible material adjacent the side by side panels so as to define a foldable hinge bridging the two adjacent panels. The envelope is slidably engaged within the chute formation of the pair of side panels until it is seated within the trough formed between the base of the chute. Means mounting a writing instrument is provided on the hinge. The panel can carry a pair of slots or storage pockets capable of storing currency or the like. Grocery coupons are to be stored within the envelope in random order. A small note pad carrying removable paper note sheets can be affixed to the second panel for making notes. The note pad can be adhesively secured to the panel or can be provided with a cardboard backing slidable through a slot formed in the panel. In use, the pair of panels can be folded along the described fold, with a pen or pencil seated along the fold.

The discount coupons for groceries are introduced into the envelope are randomly placed without any indicated relation to the grocery items for which they are intended. The shopper must “fish” for the desired coupon related to the grocery item to be purchased, causing likely delay and/or frustration. Many different coupons are stored within the single envelope, again raising the difficulty in accessing any specific coupon related to a particular grocery item to which it applies. The provision of a preprinted listing may omit those items which the shopper wants to purchase, since it is a single “standard” printed list which is likely to omit those items which the shopper may want to purchase. Only a single envelope is displayed, and, hence, use of the list pad provided is limited to use at a single destination. If a different destination is to be covered during the shopping trip, the single envelope would have to be replaced discounting use thereof and replacement with a second envelope stored in the single unit, the first used envelope would have to be separated and, likely, would have to be removed from the unit, with whatever unused grocery coupons remaining having to be carried separately. The Suryk unit would be limited to one destination rather than being useful for a multi-destination shopping trip.

Cue discloses a foldable wallet including a notepad and a coupon caddy or storage envelope for coupons according to according to the type of merchandise and for separating the coupons according to expiration dates and having a single top-opening unitary expansible envelope having plural dividers inserted to sort the coupons into classes, the envelope being accordion pleated along its sides. The envelope is unitary with the apparently rigid wall of the wallet. The dividers each have an indexing tab. The other apparently rigid wall of the wall mounts a color-coded lined note pad having removable lined sheets. The spine of the wallet carries a mounted pen (or pencil) and apparently is rigid. The apparently rigid wall carrying the sides and the dividers mounted therein, extends outward and has a bendable closure flap carrying a (“hook and pile”) “Velcro” closure.

Martin provides an organizing system for coupons resembling a rigid tool box. The box is a hard-shell hinged unit with a carrying handle. The hinged box opens to display plural “category” pockets designating different types of goods. The pockets are capable of receiving index cards identifying specific products and are capable of receiving separated coupons relating to the specific products. The pockets are arranged in a series, each having identifying tabs protruding from one side thereof. Each pocket is intended to represent a specific identified product or type of product, and is intended to receive a coupon related to that identified product. The pockets comprise coupon holders and do not have any function as list means, list means are provided separately in the form of loose pages separate from the individual storage pockets. The box unit has other plural containers for writing instruments, checkbook holder, key ring holder, calculator, mounting means for holding a pad of papers, a scissors holder—in other words, means for distributing items associated in the shopping tool category. A considerable disadvantage of the unit is its bulk, which can reduce the convenience of its use.

Benham provides a multiple pocket folder and a pair of cover panels, one of which is suitable to hold a notepad, the folder being formed of a one-piece paperboard blank folded to form a multiple pocket accordion-pleated portion for holding coupons.is accordion pleated defining unitary open sided plural pockets for receiving coupons. One of the rigid panel functions as a closure panel while the other panel is provided with means to mount a slit or holes by which a memo pad can be mounted. The Benham folder is formed by folding a pre-scored blank, but can be unduly thick when employed in view of the bulk of the coupons likely to be stored within the folds, particularly considering the bulk of the assembled unit when employed for a here still is the problem of correlation of the coupons with particular items selected on the shopping list and with no relief for the bulk of the loaded unit during the shopping trip preparation and process.

Ciaria et al provides a wallet for use by a waiter or waitress in a restaurant or cafe, for holding order checks, the wallet comprising a right and left hand cover, one cover having a small multi-page pad and the other cover carrying plural clear plastic envelopes. The envelopes are secured to the left hand cover. Each of the envelopes are provided with tabs. Each of the pages of the multi-page pad is removable and attachable to the respective envelopes for identifying the content of each of the envelopes. Again, there is an absence of a means for storing and retrieving small coupons and relating same to a listing or other indicia carried by the paper pad associated with the right hand cover. There is no relationship between the items written on the “checks” carried by the right hand cover and the content of each envelope of the multi-page envelope. The assembled envelopes and the assembled note pages are separate units.

### SUMMARY OF THE INVENTION

The present invention comprises a bound multi-page shopping list pad having a stack of plural pages, each page formed of a pair of superposed thin sheets and a backing member joined at one end thereof, one of said sheets being a horizontally lined note or memo sheet and the second sheet joined to the note sheet along three edges thereof to define a side opening pocket for holding coupons particularly related to the items listed on the note sheet. The plural pocket carrying “dual” pages may be stapled together or bound with tape to the backing member at one end of the stack and may be scored to enable selective removal of each from the stack The backing member may be provided with a magnetic strip or disc adjacent the bound end to facilitate adherence of the pad to a metal surface, such as a refrigerator or the like.

### BRIEF DESCRIPTION OF THE DRAWING

FIG. 1 is a diagrammatic exploded enlarged representation of the pair of superimposed sheets forming a dual page of the multiple pocket shopping list pad according to the invention;

FIG. 2 is a perspective elevation of a single dual page of the shopping list pad of the invention;

FIG. 3 is a perspective elevation of a single page of the shopping list pad of the invention which is scored along one end thereof;

FIG. 4 is a perspective elevation of a single page of the shopping list pad according to the invention illustrated in side-open condition shown receiving coupons or the like, and the tab shown in the process of being unfolded;

FIG. 5 is an exploded view of the shopping list pad according to the invention;

FIG. 6 is a perspective view of the shopping list pad according to the invention, as illustrated with the top page portion of one of the single pages of the shopping list pad according to the invention being in the process of being removed;

FIG. 7 is a perspective view of the shopping list pad according to the invention, as illustrated with the top single scored page of a modified embodiment of the invention in the process of removal from the modified embodiment of the invention; and,

FIG. 8 is a perspective detail of a portion of the stack of dual pages illustrating the arrangement of the tabs spaced along the edges of the single pages of the stack.

### DESCRIPTION OF PREFERRED EMBODIMENTS OF THE INVENTION

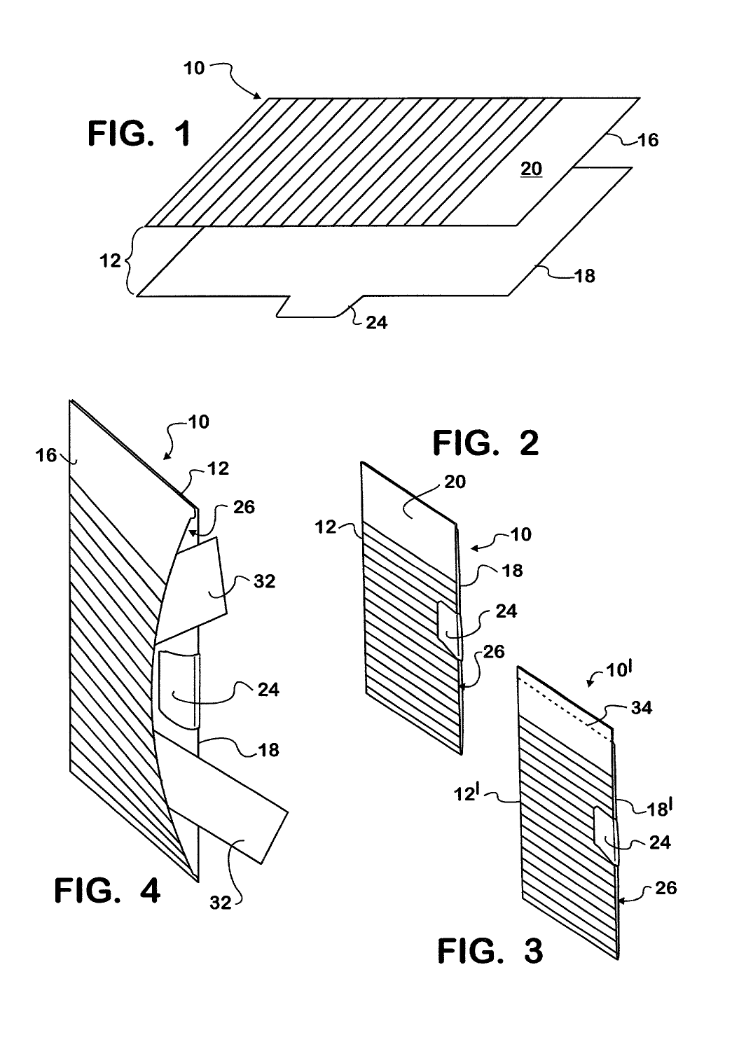

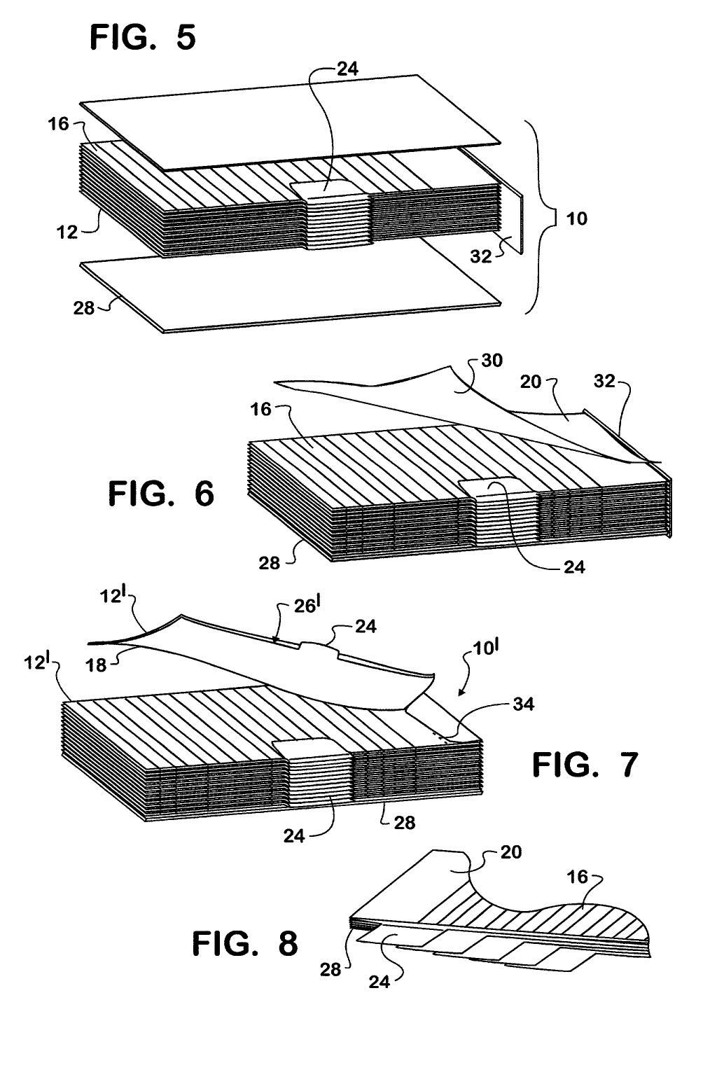

Referring to the drawings, FIG. 1 illustrates a single dual-page 12 of the body 14 of plural pages comprising the shopping list pad 10 of the invention shown in FIGS. 5 and 6. The single dual-page 12 is formed as a pair of thin, like dimensioned superposed sheet members 16 and 18. Sheet 16 is provided with equispaced printed horizontal lines along the length thereof with a top non-lined margin 20 at one end 22 thereof The sheet 16 may be formed of 18 or 20 pound paper stock such as utilized for the pages of conventional spiral memo books.

The second sheet 18 may be of the same weight as sheet 16 or may be of slightly heavier stock and may be unlined. The paper used to form sheet 18 may be 20 pound to 28 pound stock. Sheet 18 is formed with normally outwardly extending and inwardly foldable tabs 24 along one edge thereof The tabs 24 may be formed of a type of pressure sensitive paper such as manufactured and sold under the trademark “POST IT” by 3-M Corporation may be located on each second sheet 18 to form respectively lengthwise graduated spaced locations along the length of said one edge of each of the sheets 18, so that when the dual-pages are arranged in their stack formation, a series of tabs may line up spaced and respectively aligned at the same location along the length of said edges of the stack of the dual-pages so as to be aligned with tabs of other second pages or located in a respective series extending each outward in a spaced series along the length of the respective ones of said dual-pages of the stack or at the same location along the length of the other second pages carried by others of the plural second pages 18 of the shopping list pad 10. The plural dual-pages 12 are bound along their top edges by bindings (not shown) or may be stapled together along their ends with their edges aligned.

A non-illustrated modified example of the dual-page 12 of a list pad constructed in accordance with the invention has a wide-ruled list sheet 16 which is 9.0 cms. wide and 14.8 cms. long with the printed lines being spaced apart 0.9 cm. and a unlined sheet 18 of the same 9.0×14.8 cms dimension.

The printed lines of the sheets 16 are intended to receive data such as identifying individual grocery items to be obtained by the user in the course of the shopping trip, say to an individual grocery store during a visit thereto in the course of the particular shopping trip. Some of these grocery items may be on sale on the particular day of the shopping trip, and hence, may be the subject of respective discount coupons, perhaps severed from the newspaper advertisements or otherwise from flyers taken from other publicly circulated flyers. A particular sheet 16 of dual page 12 may be used to note items from one store with the discount coupons being stored within the pocket carried by that page. On many occasions, the purchaser may peruse newspaper advertisements appearing on different dates, note the sale items and clip the necessary coupons, storing them within that pocket for use on a selected advance day. Other store's items may be written on additional dual-pages of the shopping list pad of the invention, each individual page containing listings relating to items originating from different stores. There may be meat markets, hardware stores, department stores, etc. each of which offering items to be purchased by the shopper. A shopping trip may cover visits to a plurality of different vendors, each of which may be offering discount coupons for sale items, these coupons having been retrieved, sorted and saved for use in the course of the particular shopping trip. Likewise, the shopping trip may include seeking gift items for friends or family members. Receipts for each of these purchases may be required for the giftee to constitute evidence of purchase so as to enable exchange of the gift for size or other reason. These receipts can be stored within the pocket of that dual-page of the list pad, the list sheet of which carries the notation listing that particular gift. Now upon request, the receipt can be retrieved and given to the particular giftee.

Items relating to the plural discount coupons have been separated and sorted by the user purchaser, each list prepared and each pocket 26 thereof carrying the respective sorted discount coupons coordinated with each list. Instead of being gathered together as a heterogeneous group mixed together and/or separated and clipped together in groups, as has been the conventional practice, they are placed within specific ones of the pocket carrying pages, as has been the conventional practice, the respective sorted groups can be placed within specific ones of the pages of the shopping list pad of the invention, and are thus are handy when need to access same arises. since they are separated and contained within the appropriate pocket 26 of the dual-page to which they belong being within specific ones of the dual-pages of the shopping list pad of the invention to which each is related. The coupons thus are not mixed up, separated and/or lost, say within the pocket or purse of the purchaser as the shopping trip proceeds. Probably the most often encountered situation facing the shopping purchaser is the difficulty in accessing the particularly desired coupon from the purchaser's pocket or purse as well as accessing the prepared shopping list. As shown in the FIGURES, each of the dual-pages 12 may be provided with an outwardly extending pressure sensitive tab 24 extending outward along the edge of the second sheet 18 thereof, and, as shown in FIG. 2, can be folded over the side-opening pocket 26 defined between the list sheet 16 and the second sheet 18 so as to close the pocket 26 when coupons have been inserted within said pocket 26 for preventing escape of the discount coupons being stored therewithin. In FIG. 2, the page is illustrated in its condition prior to use, the tab 24 being folded over the edge of the page 12.

As shown in FIG. 4, after the particular item has been listed on the sheet 16, the tab 24 is unfolded to open and expose the pocket, once the discount coupon 32 related to the item is inserted within the pocket 26, the tab folded over the list sheet 16, closing the pocket 26.

In FIGS. 3 and 7, dual-page 12′ of a modified embodiment 10′ of the multiple pocket shopping list pad according to the invention is illustrated and is characterized by, alternatively, the dual-page 12′ itself or only the note, or listing sheet 16 is scored horizontally across a location spaced from the upper end of the sheet to facilitate removal of the note or listing sheet 16′ or the entire page 12′ from the multiple pocket shopping list pad 10′.

Referring to FIG. 5, there is illustrated a partially exploded view of a further modified embodiment of the multiple pocket shopping list pad of the invention which is designated by reference character 10, wherein the dual-pages 12 are arranged in a stack consisting of a plurality of individual dual-pages 12 mounted on a backing member 28 such as shown in FIGS. 5-8 which can be formed of a rigid cardboard or, alternatively, a slightly more flexible material such as plastic or synthetic or natural leather. A flexible cover sheet 30 is provided which can be formed of paper, heavier than the sheet 18 of dual-page 12. Alternatively, the cover sheet 30 may be formed of plastic coated paper, of card stock range material, plastic material even 40 pound paper stock. The cover sheet 30 may be formed of more flexible material. The multiple pocket shopping list pad 10″ is bound with a binder 32 at the upper end thereof The stack of dual-pages may be secured together at one end thereof by a spiral type member (not shown) line lieu of a binder.

The backing member 28 may be formed for example, of 80 pound paper stock or may be formed of other relatively stiff material such as card-stock, paper board or cardboard. The stack may be provided with a cover sheet 30 such as shown in FIG. 6.

In FIG. 6, the cover sheet 30 is formed of a flexible material such as a heavier paper stock such as the card-stock range or plastic coated stock and is shown in the process of being lifted to expose the stack of dual-pages 12 bound at its upper end with a binder 32 such as plastic or cloth tape, for example. The sheets 12′ are stacked, the cover sheet 30 being illustrated in the process of being lifted to gain access to the individual dual-pages 12 or 12′ being removed from the stack of multiple dual pages 12 or 12′. The top edges of individual ones of the individual pages are secured to the binder 32

In FIG. 7, the multiple pocket shopping list pad 10′ consists of a stack of dual-pages 12′ secured with the top edges adhered to a binder member 32, one of the dual-pages being illustrated in the process of being separated from the stack by being drawn along the score line 34 with the tab folded over the sheet 16 thereof, the pocket 26 being closed by folding the outwardly extending portion of the tab 24 over the list sheet 16 after use thereof at a time subsequent to completion of the shopping activity.

With the use of the multiple pocket shopping list pad, the user avoids the misplacement of the shopping list, the discount coupons, tickets, receipts, etc. The closure of the portions hold the pocketed items within the side-opening pocket 26. The multiple pocket shopping list pad 10 is light in weight, highly useful, convenient and effective in achieving the long desired result long sought. Other prior efforts result in objects that are bulky, inconvenient to carry and to use; It will be understood that variations of construction can be contemplated by those skilled in the art without departing from the scope of the invention as set forth in the claims appended hereto.

I claim:

1. A multiple pocket shopping list pad comprising
a) plural dual-pages, each formed of lined thin first sheet and a second sheet of the same perimetric configuration as said first sheet and superposed thereon, said first and second sheets being joined along three sides to define a side-opening pocket;
b) a backing member carrying said plural dual-pages arranged in an aligned stack secured together along one common end thereof;
c) said first sheet capable of carrying a written shopping list applied thereto and said side-opening pocket capable of receiving and storing therein individual insert sheets directly related to items identified in said written shopping list page and,
d) each of said dual-pages being capable of being selectively separated from the stack thereof.

2. The multiple pocket shopping list pad according to claim 1 in which said first sheet is scored to enable separation thereof from said dual-page.

3. The multiple pocket shopping list pad according to claim 1 in which each dual-page is scored along a horizontal line spaced from one end thereof enabling the selective separation thereof from said stack.

4. The multiple pocket shopping list pad according to claim 1 in which said second sheet is formed of a weight of the first sheet.

5. The multiple pocket shopping list pad according to claim 1 in which said second sheet is formed of a weight greater than the weight of said first sheet.

6. The multiple pocket shopping list pad according to claim 1 in which said pad includes a cover sheet of weight greater than the weight of each of said first and second sheets respectively.

7. The multiple pocket shopping list pad according to claim 1 in which said backing member is rigid.

8. The multiple pocket shopping list pad according to claim 1 in which said backing member has limited flexibility.

9. The multiple pocket shopping list pad according to claim 1 in which at least one of pockets is capable of receiving and storing plural coupons at least some of which are directly related to specific items identified in said written items applied to said listing carrying sheet of said dual pages.

10. The multiple pocket shipping list pad according to claim 1 in which said stack of dual-pages is bound across one end thereof.

11. The multiple pocket shopping list pad according to claim 1 and magnetic means secured to said backing member enabling said multiple pocket list pad to be suspended from a relatively flat metal surface.

12. The multiple pocket shopping list pad according to claim 1 in which said first sheet is formed of paper of 18 pound weight.

13. The multiple pocket shopping list pad according to claim 1 in which said first and second sheets are formed of paper of 18 pound weight.

14. The multiple pocket shopping list pad according to claim 1 in which said dual-pages are stapled together horizontally across one of the ends thereof to form said stack thereof.

15. The multiple pocket shopping list pad according to claim 11 in which said second sheet is formed of a weight greater than the weight of said first sheet.

16. The multiple pocket shopping list pad according to claim 1 in which said dual-pages are secured to a binding member forming said stack thereof.

17. The multiple pocket shopping list pad according to claim 1 in which each of said second sheets have a tab extending outwardly from one of the free edges thereof.

18. The multiple pocket shopping list pad according to claim 16 in which said tabs are individually spaced substantially uniformly along one of said free edges of each of said dual-pages.

19. The multiple pocket shopping list pad according to claim 17 in which said tabs are formed of folded pressure-sensitive material.

20. The multiple pocket shopping list pad according to claim 17 in which said tabs are unitary with said second sheet.
